(19) United States
(12) Patent Application Publication
(10) Pub. No.: US 2024/0280478 A1
(43) Pub. Date: Aug. 22, 2024

(54) GAS SENSOR AND METHODS OF OPERATING THEREOF

(71) Applicant: BAH Holdings LLC, Sea Cliff, NY (US)

(72) Inventors: Michael Tkachuk, Sea Cliff, NY (US); Solovyov Vyacheslav, Sea Cliff, NY (US); Tony Providenti, Sea Cliff, NY (US); Charles Scolaro, Sea Cliff, NY (US)

(21) Appl. No.: 18/110,660

(22) Filed: Feb. 16, 2023

(51) Int. Cl. G01N 21/3504; G01N 21/31

(52) U.S. Cl. CPC G01N 21/3504; G01N 21/314; G01N 2021/3166; G01N 2021/317; G01N 2021/3181

(57) ABSTRACT

A selective gas sensor designed to operate for extended period of time. The sensor selectivity to specific gases is achieved by implementing a bandpass filter that selectively filters the interference signal from common hydrocarbons. Stability is accomplished by application of two reference detectors, one responsible for the temperature compensation and another responsible for the mirror and filter aging.

### FIELD OF THE INVENTION

This invention relates to improved, low cost and low power sensors for the measurement of concentration of a target gas by means of optical absorption. In particular, the invention relates to apparatuses and methods for non-dispersive infrared (NDIR) measurement based on the absorption of radiation by the gas of interest.

### BACKGROUND

In industry is often required to detect the presence of various species of flammable gases, such as methane, propane, butane and others. Equally, in some fields it is necessary to selectively detect species of gas—e.g., to identify methane from propane, butane or other hydrocarbons.

Gas sensing can be realised by an electrochemical method as described in “Solid State Gas Sensing” edited by Elisabetta Comini, Guido Faglia, Giorgio Sberveglieri, Springer Verlag Berlin Heidelberg, 2009. However, this method is poorly suited for chemically passive gases such as methane or ethane and has poor selectivity.

Combustible gases can be sensed by a hot filament or a heated catalyst device which measures the rate of catalytic oxidation of the gas in air. An example of such a device is a catalytic Pellistor described in “A Low-Power Integrated Catalytic Gas Sensor”, Krebs, P. and A. Grisel. Sensors and Actuators B-Chemical, 1993. 13(1-3): p. 155-158. These devices are typically designed to detect a combustible gas. Generated heat changes the resistance of the detecting element of the sensor proportional to the gas concentration. These devices require significant amount of power to operate, and cannot be practically designed as portable devices. Also, these devices do not differentiate between species of various flammable gases, thus being susceptible to false alarms.

Optical absorption techniques such as non-dispersive infrared (NDIR) measurement have been recognized for many years as sensitive, stable and reliable methods of gas concentration measurement. In a typical NDIR method, the selective absorption of infrared radiation by certain gas species of interest is measured to determine the concentration of the target gas in a sample. This has a wide variety of applications—for example, NDIR measurements detecting absorption of radiation by carbon dioxide and other gases, such as carbon monoxide or hydrocarbons, are commonly used to monitor atmospheric composition or automotive exhaust, as well as in fire detectors.

These conventional NDIR techniques utilize strong optical absorption lines of common gases in 1-5 micrometer (μm) range of wavelengths for identification of the target gas species. A conventional NDIR instrument typically includes the following elements: a source of radiation (usually infrared), such as an incandescent lamp or another electrically heated element that serves as a blackbody emitter, e.g. a silicon carbide rod or nichrome filament; a gas chamber for containing a sample including the target gas of interest; and a photodetector for detecting radiation transmitted by the sample and transforming the intensity of the detected radiation into an electrical signal.

Within these instruments an incandescent bulb or other electrically heated element which acts as a blackbody emitter may be used as the source of radiation. However, these components typically consume several Watts of electric power, which makes this approach practical only for wired installations. Other designs include infrared lasers. These instruments tend to be very sensitive but are prohibitively expensive for many applications due to the cost of the lasers involved. Infrared light-emitting diodes (LED) can replace the laser with an acceptable loss in sensitivity, however, the emission spectra of a LED is relatively broad and affected significantly by temperature. Thus it is difficult to produce a sensor involving an LED that is good selectivity—i.e. is capable of distinguishing different gases from one another—and is capable of operating over a wide temperature range.

Regardless of the radiation emitter, it is particularly difficult to distinguish common hydrocarbons using NDIR since their absorption spectra overlap significantly. For example, FIG. 1a shows absorption spectra of hydrocarbons in the range of 2.7 to 4 micrometers and FIG. 1b shows transmittance of methane, benzene and propane again in the range of 2.7 to 4 micrometers. Thanks to the overlapping absorption spectra, it is difficult to develop a NDIR sensor that can reliably distinguish flammable gases from one another, especially the flammable gases present in natural gas which include methane, propane and butane (among others).

Distinguishing between different hydrocarbons using known NDIR devices and methods is particularly difficult at low concentrations. For example, propane can leak from household appliances that use liquified propane tanks. It is difficult to distinguish between a hydrocarbon of interest at low concentrations and such a propane leak.

The aim of this invention is to overcome some of the problems identified above.

### SUMMARY OF INVENTION

To solve the problems discussed above, there is provided a selective gas sensor designed to operate for extended periods of time (e.g. more than 10 years). Preferred sensors have high selectivity to methane, which is achieved by implementing a bandpass filter that selectively filters the interference signal from common hydrocarbons such as propane. Stability can be accomplished by the use of two reference detectors (receivers), one responsible for temperature compensation and another responsible for the mirror and filter aging. For example the gas sensor may comprise a reference detector responsible for temperature compensation and another responsible reference detector to compensate for the aging of components within the sensor.

According to an aspect of the invention there is provided a gas sensor for detecting the concentration of methane in a gas sample, the gas sensor comprising: a sample chamber for containing the gas sample; a light emitting diode arranged to emit infrared radiation into the sample chamber; a first infrared detector configured to output an output signal based on the radiation it receives; and a bandpass filter configured to filter radiation passing therethrough; wherein the light emitting diode, bandpass filter and first infrared detector are arranged such that at least a portion of the radiation emitted from the light emitting diode is transmitted through the bandpass filter and along a first optical path through the sample chamber before being received by the first infrared detector; wherein the bandpass filter has a full width at half maximum, FWHM, in the range from 70 nm to 300 nm and an upper cut-off wavelength of less than or equal to 3350 nm; wherein the upper cut-off wavelength is the wavelength at which the bandpass filter has a transmittance of 5% of the maximum transmittance of the bandpass filter, the upper cut-off wavelength being greater than a peak wavelength of the bandpass filter at which maximum transmittance occurs; and wherein the FWHM is the difference between the wavelengths at which the transmittance of the bandpass filter is at 50% of the maximum transmittance of the bandpass filter.

Therefore, for the first time the inventors have recognised that methane can be selectively identified in comparison to gases such as propane and butane by an NDIR gas sensor that includes an optical bandpass filter which transmits electromagnetic radiation (also referred to herein as “light” or “radiation”) across a specific, narrow range of wavelengths. This range of wavelengths centred at approximately 3250 nm is selected not to correspond to the peak absorbance wavelength of methane, where significant proportion of radiation (i.e. light) is absorbed by methane, but is instead chosen to fall in a range where gases such as propane and butane are significantly worse absorbers than methane. This enables methane to be easily distinguished from other hydrocarbons such as propane.

By way of example, FIG. 2 shows an exemplary filter transmission spectrum for a bandpass filter that may be used in the invention in comparison to the absorption spectra for methane and propane. As will be seen, the filter has a narrow spectral range and transmits radiation—and therefore the sensor will accept radiation—across the narrow region of approximately 3.2 to 3.3 micrometers (3200 to 3320 nm). Although the peak of the methane absorption spectra is higher than the acceptance band of the filter at approximately 3.32 micrometers, it still absorbs a significant proportion of radiation throughout the 3.2 to 3.3 micrometers band admitted by the filter. In contrast, propane has a peak absorption well above the acceptance band of the filter and absorbs very little radiation below 3.3 micrometers (3300 nm).

Therefore, a gas sensor in accordance with the invention that uses the bandpass filter shown in FIG. 2 is able to distinguish between gas samples containing methane and gas samples containing propane, since less radiation will pass through samples containing methane than samples containing propane. This distinction could not be made if the filter transmitted significant amounts of light at higher wavelengths—e.g. above 3.35 micrometers or in the range of 3.35 to 3.50 micrometers (3350 nm to 3500 nm)—since at these wavelengths propane and methane both absorb significant proportions of radiation.

Therefore, even if a gas sample is radiated by (for instance) an infrared LED with a relatively wide emission spectrum, the gas detector may be very accurate and highly selective for sensing methane. The light reaching the detector is filtered to remove information that relates to the absorption of propane.

The sensor can include an infrared LED and photodetector that are relatively cheap. The sensor may operate at room temperature and does not need to be actively cooled, which enables a compact and low-power sensor. The sensor operation is based on absorption of the infrared radiation by the gas volume.

Herein the term “infrared” (also commonly termed “IR”) is understood to refer to a portion of the electromagnetic radiation spectrum with wavelengths from approximately 700 mn to 1 mm. Thus infrared refers to radiation (i.e. light) with wavelengths longer than those of visible light but shorter than microwaves or radiowaves.

Preferably, the infrared LEDs discussed herein emit light across at least the acceptance band of the bandpass filter extends. Similarly the infrared detectors discussed herein preferably absorb light across at least the acceptance band of the bandpass filter extends. Therefore, the infrared LEDs and the infrared detectors preferably emit and absorb radiation respectively across a range of at least 3100 nm to 3400 nm.

In preferred examples, the maximum transmittance of the bandpass filter is at least 65%. Transmittance will be understood as the fraction of incident light (radiation) which is transmitted by a substance, and the maximum transmittance will be understood as the peak value of transmittance across all wavelength of radiation. More preferably the maximum transmittance is at least 70%, and more preferably still at least 75%, at least 80% or at least 85%. Increasing the maximum transmittance of the bandpass filter increases the accuracy of the gas sensor as the amount of light passing through the gas sample and bandpass filter to the detector is increased and the effects of noise are reduced. Nevertheless, in other examples the bandpass filter may still have a lower maximum transmittance.

Preferably the peak wavelength, at which maximum transmittance of the bandpass filter occurs, is preferably in the range from 3200 nm to 3260 nm. A peak wavelength (also commonly referred to as a central wavelength) for the bandpass filter in this range is well matched to the absorption spectra of methane but distinguished from the absorption spectra of propane and butane (as can be seen from FIGS. 1 and 2). For example, the peak wavelength may preferably be approximately 3250 nm or in the range of 3225 and 3260 nm.

Preferably the FWHM of the bandpass filter is in the range of 80 nm to 200 nm, or more preferably 80 nm to 120 nm. Filters with a narrower acceptance band—e.g. as measured by the full width at half maximum—allow for increases in the selectivity and accuracy of the gas sensor for methane. Data received from outside the wavelength range of interest is reduced.

Preferably, the upper cut-off wavelength of the bandpass filter is in the range of 3275 nm to 3325 nm.

Preferably, the band pass filter has a lower cut-off wavelength in the range from 3100 nm to 3200 nm, wherein the lower cut-off wavelength is the wavelength at which the bandpass filter has a transmittance of 5% of the maximum transmittance of the bandpass filter, the lower cut-off wavelength being smaller than the peak wavelength of the bandpass filter at which maximum transmittance occurs. The lower cut-off wavelength is sometimes also referred to as a cut-on wavelength.

At wavelengths above the upper cut-off and below the lower cut-off of the bandpass filter (i.e. at wavelengths outside the acceptance band of the bandpass filter) the transmittance is preferably less than 5%, more preferably less than 2%, more preferably still less than 1%.

The upper cut-off wavelength and lower cut-off wavelengths respectively define an upper and lower limit of the acceptance band of a bandpass filter. At wavelengths between the upper cut-off wavelength and lower cut-off wavelengths a high proportion of radiation is transmitted by the filter. Whilst at wavelengths over the upper cut-off wavelength and below the lower cut-off wavelengths a low proportion (e.g. less than 5%) of radiation is transmitted. Specifically, as understood herein the upper cut-off wavelength and lower cut-off wavelengths are wavelengths at which the bandpass filter has a transmittance of 5% of the maximum transmittance. Thus the upper and lower cut-off wavelengths and the FWHM together help define the width of a bandpass filter.

From the details above it will be appreciated that in preferred examples the distance between the upper and lower cut-off wavelengths may be less than 200 nm, and is preferably in the range of 120 to 160 nm.

Preferably the upper slope of the transmission spectrum of the bandpass filter has an average gradient in the range of 0.5% to 1.5%, wherein the upper slope is the region between an upper shoulder wavelength that is greater than the peak wavelength and at which the transmittance of the bandpass filter is 80% of the maximum transmittance value of the bandpass filter and the upper cut-off wavelength. More preferably this average gradient should be in the range of 0.7% to 1.2%. This average gradient for the lower frequency side of the acceptance band of the band pass filter is sometimes referred to as the “cut-on slope” or “slope”

Preferably the lower slope of the transmission spectrum of the bandpass filter has an average gradient in the range from 0.5% to 1.5%, wherein the lower slope is the region between the lower cut-off wavelength and a lower shoulder wavelength that is smaller than the peak wavelength and at which the transmittance of the bandpass filter is 80% of the maximum transmittance value of the bandpass filter. More preferably this average gradient should be in the range of 0.7% to 1.2%. This average gradient for the lower frequency side of the acceptance band of the band pass filter is sometimes referred to as the “cut-on slope” or “slope”

These slope values define a steep increase in the sides of the acceptance band of the bandpass filter. This high “roll-off” ensures that the bandpass isolates radiation containing data indicative of methane concentrations in the methane in the region of interest (approx. 3250 nm). This increases accuracy and selectivity.

It will be understood that the optical properties and transmission spectra of a bandpass filter may vary with temperature. The properties and parameters of the bandpass filter discussed above will be understood as properties or parameters when measured at room temperature—e.g. at approximately 20 degrees Celsius or in the range of approximately 20 to 25 degrees Celsius. Similarly the properties of LEDs and infrared detectors may also vary with temperature. Again, specific properties or parameters discussed herein are understood to be properties or parameters of the component in question when measured at room temperature—e.g. at approximately 20 degrees Celsius or in the range of approximately 20 to 25 degrees Celsius.

As discussed above, the first infrared detector is configured to convert incident radiation into a signal (e.g. an electrical signal). The radiation incident on the first infrared detector has passed through the gas sample and the bandpass filter. Therefore, the signal produced by the first infrared detector will containing information indicative of whether methane is present in the target gas sample due to the overlap between the acceptance curve of the bandpass filter and the absorption spectrum of methane. The output signal produced by the first infrared detector is preferably dependent on the intensity of the radiation incident on the first infrared detector. However, in further examples, the signal may be dependent on other properties of the radiation received by the first infrared detector (e.g. spectral intensity, irradiance, spectral irradiance or other spectral properties of the incident radiation).

Preferably the first infrared detector, and other infrared detectors discussed herein, are photodiodes. However, alternative detectors that can convert radiation into electrical signals such as phototransistors may alternatively be used for the detectors discussed herein. Together the LED and the first infrared detector may be termed an optopair.

Preferably the gas sensor comprises a first mirror positioned along the first optical path and configured to reflect radiation from the light emitting diode to the first infrared detector. The proportion of light travelling through a gas sample that is absorbed by the gas will depend in part on the concentration of the gas and on the distance the light travels through the gas—i.e. the length of the first optical path described above. Increased levels of absorption are achieved by increasing the distance along which radiation travels through gas—for instance by using a mirror to reflect the radiation such that it passes through the gas sample multiple times. In turn, increasing the levels of absorption by the gas will increase the information content relating to the target gas within the output signal produced by the infrared detector and decrease the signal to noise ratio. The use of such a mirror allows the gas sensor to be reduced in size whilst retaining a first optical path of similar length and similar levels of accuracy. Alternatively, similar improvements in accuracy can be achieved by increasing the size of a sample chamber and the amount of gas contained in the sample chamber in use.

For example, in some arrangements of the gas sensor the LED and the infrared detector may be located relatively close to or adjacent to one another, whilst radiation must take a relatively long route between the two components via a mirror. In some examples the LED and the infrared detector may be mounted on a single circuit board.

Additionally or alternatively the LED and the infrared detector may be located on a first side of the sample chamber and the first mirror may be located on an opposing second side of the sample chamber. As used herein, the term mirror is understood to refer to body with a reflective surface that reflects electromagnetic radiation with wavelengths in at least the range of interest, that is the mirror reflects radiation with wavelengths in the range of interest from approximately 3100 to 3400 nm.

Preferably the first mirror is concave, parabolic or substantially spherical. In other words, it will be understood that the mirror comprises flat, concave, parabolic or spherical reflecting surface arranged to reflect radiation from the LED to the infrared detector. Mirrors with concave, parabolic or substantially spherical reflecting surfaces are particularly preferred since they can focus reflected radiation toward a single focus. Preferably these mirrors are arranged to reflect incident radiation from the LED and focus the reflected radiation on the infrared detector. This increases incident light at the detector, thereby increasing the information content relating to the sample gas in the signal output by the detector and reducing the signal to noise ratio from the detector. Hence accuracy of the gas sensor may be increased without increasing the size of the gas sensor.

Preferably the gas sensor further comprises: a second infrared detector configured to output a short path reference signal based on the radiation it receives; wherein the light emitting diode and the second infrared detector are arranged such that a portion of the radiation emitted from the light emitting diode is transmitted along a second optical path through the sample chamber before being received by the second infrared detector; wherein the length of the first optical path through the sample chamber is greater than the length of the second optical path through the sample chamber. The short path reference signal output by the second infrared detector is preferably dependent on the intensity of radiation incident on the second infrared detector. However, in further examples, the signal may be dependent on other properties of the radiation received by the first infrared detector (e.g. spectral intensity, irradiance, spectral irradiance or other spectral properties of the incident radiation). Together the LED and the second infrared detector may be termed an optopair.

Providing a second infrared detector that receives light that has passed through a relatively small amount of the sample gas allows for the accuracy of the gas sensor to be maintained across a wider range of operational conditions. The short path reference signal output by the second infrared detector will contain significantly less information regarding the sample gas as significantly less radiation travelling along the short second path be absorbed by the gas than the light travelling along the long the first path.

Nevertheless, the short path reference signal can be used to provide information regarding the LED emission spectra and power, the transmittance of the bandpass filter and any mirrors (as discussed below). The properties of LEDs, bandpass filters and mirror can vary with environmental conditions such as temperature. Therefore, it is possible to correct the output signal from the first infrared detector for variations in the properties of the other components of the gas sensor using the short path reference signal. Such processes for compensating for environmental conditions will be discussed further below.

Preferably the second infrared detector is a photodiode or phototransistor. More preferably the second infrared detector is of a similar design or substantially identical design to the first infrared detector.

Preferably the length of the first optical path is at least twice the length of the second optical path. As such, the short path reference signal contains significantly less information regarding any gas within the sample chamber. In further examples the length of the first optical path may be at least 2.5 or 3 times the length of the second optical path.

Preferably the gas sensor comprises a second mirror positioned along the second optical path and configured to reflect radiation from the light emitting diode to the second infrared detector. A second mirror can help reduce the size of the gas sensor. However, in particularly preferred examples the second mirror comprises substantially the same structure or substantially the same construction as the first mirror. In this situation the short path reference signal will contain relatively little information regarding a sample gas in the sample chamber but will contain information regarding the properties of the infrared radiation emitted by the LED, second infrared detector the second mirror and the bandpass filter. The signals produced by the second infrared detector may vary because of changes to environmental conditions such temperature or humidity, for example, which can affect the optical properties of the components of the gas sensor. Where the first and second mirrors have similar properties the short path reference signal may also be used to compensate for variations in the properties of the mirrors with changing environmental conditions.

Where the first and second mirrors have similar properties the short path reference signal may also be used to compensate for variations in the properties of both mirrors (e.g. during manufacture, with environmental conditions or with age).

The second mirror may be a separate component to the first mirror and may be located closer to the LED and/or the photodetector than the first mirror. However, in other examples the first and second mirrors may be separate sections of a single mirror and in these cases the different lengths of the first and second optical paths may be formed by arranging the second infrared sensor closer to the mirror than the first infrared sensor.

Preferably the second mirror is concave, parabolic or substantially spherical. In other words, it will be understood that the second mirror comprises flat, concave, parabolic or spherical reflecting surface arranged to reflect radiation from the LED to the infrared detector. Mirrors with concave, parabolic or substantially spherical reflecting surfaces are again particularly preferred since they can offer improved accuracy as increased amounts of radiation may be focused to the infrared detector.

Preferably the light emitting diode, bandpass filter and second infrared detector are arranged such that a portion of the radiation emitted from the light emitting diode is transmitted through the bandpass filter and along the second optical path through the sample chamber before being received by the second infrared detector. The short path reference signal produced from light that passes through the bandpass filter will contain information regarding the properties of the bandpass filter. Therefore, it is possible to correct the output of the gas signal for variations of the properties of the bandpass filter with temperature or other conditions. In preferred examples the bandpass filter may be arranged over or across the LED such that all light entering the sample chamber is filtered by the bandpass filter.

In particular preferred embodiments the gas sensor comprises: a third infrared detector configured to output an internal reference signal based on the radiation it receives; wherein the light emitting diode and the third infrared detector are arranged such that a portion of the radiation emitted from the light emitting diode is received by the third infrared detector from the light emitting diode without being transmitted through the sample chamber.

The third infrared detector enables further compensation or correction of the output signal and thereby further improvements in the accuracy of sensing results from the gas sensor. The third infrared detector will receive radiation that has not been transmitted through the sample chamber or the bandpass filter or reflected by the first or second mirrors (where present). As such, the internal reference signal output by the third infrared detector can provide information on the properties of the LED alone. The third infrared detector preferably outputs a signal dependent on the intensity of radiation incident on it. However, in further examples, the signal may be dependent on other properties of the radiation received by the first infrared detector (e.g. spectral intensity, irradiance, spectral irradiance or other spectral properties of the incident radiation).

As the optical properties of the LED vary (e.g. with temperature) the output signal and short path reference signal may be adjusted to account for these variations. Similarly, the third infrared detector and its internal reference signal may be used to calibrate the gas sensor by providing information of the LED and its emission spectra before gas sensing is performed.

Preferably the light emitting diode and the third infrared detector are arranged such the radiation received by the third infrared detector from the light emitting diode is transmitted along a third optical path, and wherein the third optical path is shorter than the first optical path and the second optical path. Since the third optical path is relatively short, the radiation received by the third infrared detector be a truer measurement of the output of the LED since will have interacted with (e.g. reflected from or been transmitted through) fewer components of the gas sensor.

Preferably the third infrared detector is a photodiode or phototransistor. More preferably the third infrared detector is of a similar design or substantially identical design to the first infrared detector and/or the second infrared detector.

In preferred examples the third infrared detector is positioned close to the LED and is preferably adjacent to or in contact with the LED. Preferably the radiation emitted by the LED to the third infrared detector, reaches the third infrared detector without being transmitted through the bandpass filter.

In further examples the gas sensor comprises an internal chamber disposed between the light emitting diode and the third infrared detector, wherein the internal chamber is separate from the sample chamber; and wherein the gas sensor is arranged such that the portion of radiation received from the light emitting diode by the third infrared detector is transmitted along a third optical path extending through the internal chamber. The internal chamber is preferably sealed, such that it does not contain any of the sample gas present in the sample chamber. Therefore compensation of the output signal for variations in the properties of the LED is more accurate.

In preferred examples the internal chamber contains a vacuum or partial vacuum, or is filled with filled with a gas or gas mixture that is substantially transmissive to infrared radiation in the range of 3100 to 3400 nm. In particularly preferred examples the internal chamber is filled with a gas or gases that are substantially transmissive to infrared radiation in the region of interest (i.e. from approximately 3100 to 3400 nm). For instance, it may have a transmittance of less than 10% or less than 5% across this range and/or across the infrared spectrum as a whole. In these examples absorption of radiation is reduced between the LED and the third infrared detector. As such, the internal reference signal produced by the third infrared detector is a particularly accurate measurement of the output of the LED.

The gas sensor may be configured to correct or compensate the output signal from the first infrared detector using one or more of the short path reference signal and the internal reference signal.

The gas sensor may comprise a processor, the processor configured to: receive the output signal from the first infrared detector; receive the short path reference signal from the second infrared detector and/or the internal reference signal from the third infrared detector; compare the output signal with the short path reference signal and/or the internal reference signal; determine the concentration of methane in the sample chamber based on the comparison of the electromagnetic spectra of the output signal and the short path reference signal and/or the internal reference signal; and output an indication of the concentration of methane in the sample chamber.

In preferred examples comparing the output signal with the short path reference signal and/or the internal reference signal comprises calculating a ratio between the output signal and the short path reference signal and/or the internal reference signal or calculating the difference between the output signal and the short path reference signal and/or the internal reference signal. The ratio or difference between the signals quantifies the proportion of the output signal that is caused by absorption of the radiation by the contents of the sample chamber as radiation travels along the first optical path between the LED and the first infrared detector.

The magnitude of the output signal alone is a poor measurement of the presence of methane in the sample chamber. The output signal may vary with methane, but also with properties such as temperature, age of the sensor, and manufacturing variations.

The comparisons above correct for these changing conditions since the short path reference signal and internal reference signal will be similarly affected. By comparing the signals against one another it is possible to account for these issues. If the contents of the sample chamber do not significantly absorb radiation the output signal will be very similar to the short path reference signal and/or the internal reference signal. Whereas, if the output signal is significantly smaller than the short path reference signal and/or the internal reference signal significant amounts of radiation is absorbed by the contents of the sample chamber, which indicates the presence of methane in the sample chamber.

Additionally or alternatively, determining the concentration of methane in the contents of the sample chamber comprises: estimating the proportion of radiation emitted by the light emitting diode absorbed by the contents of the sample chamber based on the calculated ratio between the output signal and the short path reference signal and/or the internal reference signal or the calculated difference between the output signal and the short path reference signal and/or the internal reference signal; and calculating the concentration of methane in the sample chamber based on the estimated proportion of radiation emitted by the light emitting diode absorbed by the contents of the sample chamber. Thus the ratio or difference discussed above is converted to a measurement of methane concentration.

According to a further aspect of the invention there is provided a method for detecting the concentration of methane based on the signals detected by the gas sensors discussed above. The method comprises the following steps performed by a processor: receiving the output signal from the first infrared detector; receiving the short path reference signal from the second infrared detector and/or the internal reference signal from the third infrared detector; comparing the output signal with the short path reference signal and/or the internal reference signal; determining the concentration of methane in the sample chamber based on the comparison of the electromagnetic spectra of the output signal and the short path reference signal and/or the internal reference signal; and outputting an indication of the concentration of methane in the sample chamber.

As such, the method provides signal correction process to account for the major sources error: temperature dependence of the LED-receiver transmittance, aging of the filter and aging of the mirror surfaces. This allows for a reliable measurement of the concentration of methane in the sample. Moreover, by using the sensors comprising the bandpass filters discussed above a particularly accurate measurement of the concentration of methane is possible.

Alternative methods of signal processing are also possible. For example, in some examples, the internal reference signal may be used to generate a temperature offset coefficient. The temperature offset coefficient may be used to correct both the output signal and the short path reference signal. Next, the corrected short path reference signal may be used to generate an offset coefficient that accounts for the filter temperature dependence and the mirror aging. Applications of both offsets are then used to extract the useful, gas concentration signal.

The processor may be comprised within the gas sensor or it may be located remotely. For example, the gas sensor may be configured to transmit its signals to a remote device for monitoring or processing of the measured data. This transmission may occur over a network containing both wired and wireless components. This remote computing device may be arranged to process the signals, performing a compensation or correction of the output signal based on the short path reference signal and/or the internal reference signal in the manner discussed above.

Thus in further examples there may be provided a system comprising any of the gas sensors discussed above and a processor configured to perform the methods according to the aspect of the invention discussed above. The processor may be collocated with the gas sensor (e.g. the gas sensor may comprise the processor) or the processor may be located remotely (e.g. in a processing station).

Equally, in further examples there may be provided a non-transitory computer readable medium storing instructions which, when executed by a processor cause the processor to perform any of the methods discussed above.

According to a further aspect of the invention there is provided a gas sensor for detecting the concentration of methane in a gas sample, comprising: a sample chamber for containing the gas sample; an infrared light emitting diode arranged to emit infrared radiation into the sample chamber; a first infrared detector configured to produce an output signal based on the radiation it receives; a second infrared detector configured to produce a short path reference signal based on the radiation it receives; a third infrared detector configured to produce an internal reference signal based on the radiation it receives; a first mirror positioned along the first optical path and configured to reflect radiation from the light emitting diode to the first infrared detector; a second mirror positioned along the second optical path and configured to reflect radiation from the light emitting diode to the second infrared detector; wherein the light emitting diode, first mirror and first infrared detector are arranged such that a portion of the radiation emitted from the light emitting diode is transmitted along a first optical path through the sample chamber, reflected by the first mirror and received by the first infrared detector; wherein the light emitting diode, second mirror and second infrared detector are arranged such that a portion of the radiation emitted from the light emitting diode is transmitted along a second optical path through the sample chamber, reflected by the second mirror and received by the second infrared detector; wherein the length of the first optical path through the sample chamber is greater than the length of the second optical path through the sample chamber; and wherein the light emitting diode and the third infrared detector are arranged such that a portion of the radiation emitted from the light emitting diode is received by the third infrared detector from the light emitting diode without being transmitted through the gas sample to be tested and without being transmitted through the bandpass filter.

The gas sensor in accordance with this aspect of the invention offers significant improvements to the sensitivity of gas sensors for detecting gases. It allows major sources of error to be adjusted for: temperature dependence of the LED-receiver transmittance, aging of the filter and aging of mirror surfaces. Indeed, the methods discussed above with reference to the preceding aspect of the invention may be applied equally to the signals produced by gas sensors according to the present aspect of the invention.

Indeed, it will be appreciated that a gas sensor involving three infrared detectors may be used to produce particularly accurate measurements of gas concentrations independently of the existence of a bandpass filter selected to correspond to a particular gas.

Nevertheless, in preferred examples the gas sensor further comprises a bandpass filter configured to filter radiation passing therethrough; wherein the light emitting diode, bandpass filter and first infrared detector are arranged such that at least a portion of the radiation emitted from the light emitting diode is transmitted through the bandpass filter and along the first optical path before being received by the first infrared detector; and wherein the light emitting diode, bandpass filter and the second infrared detector are arranged such that a portion of the radiation emitted from the light emitting diode is transmitted through the bandpass filter and along the second optical path before being received by the second infrared detector. The bandpass filter may be a filter selected for methane with any of the properties discussed above with reference to the first aspect of the invention. Alternatively, the bandpass filter may be chosen for an alternative gas.

As with the preceding aspects of the invention, the output signal from the gas sensor according to this may be adjusted based on the short path reference signal and internal reference signal to produce a corrected output for the concentration of gas (or gases) within the sensor. This correction will use any of the signal correction methods discussed above in relation to the previous aspects of the invention, but may not be restricted to the measurement of the concentration of methane.

Thus gas sensors and the signal correction methods discussed above be used to detect the concentration of a wide variety of gases, especially hydrocarbon gases such as methane.

### BRIEF DESCRIPTION OF DRAWINGS

The invention will now be discussed with reference to the following drawings:

FIGS. 1a and 1b show graphs of absorption spectra of various hydrocarbons.

FIG. 2 shows a graph of transmission spectrum of an optical bandpass filter suitable for use in the invention superimposed with absorption spectra of methane and propane.

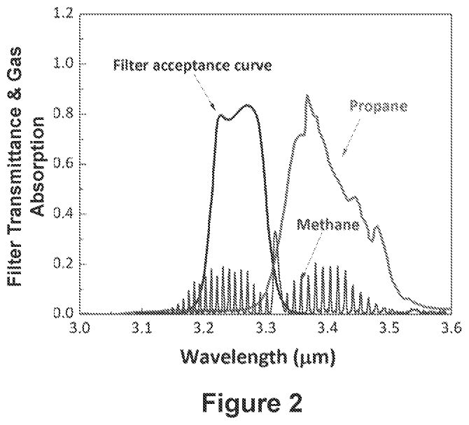

FIG. 3 shows a schematic cross section of a gas sensor in accordance with the invention.

FIGS. 4a to 4c show a schematic cross section of further gas sensors in accordance with the invention which each comprise multiple infrared detectors.

FIG. 5 shows a perspective cross section of a gas sensor in accordance with the invention.

FIG. 6 shows a flow chart of a method for calculating the concentration of a target gas according to the invention.

FIG. 7a shows a flow chart of a method for calculating the concentration of a target gas according to the invention.

FIG. 7b shows a flow chart of a method for calculating the concentration of a target gas according to the invention.

FIG. 8 shows a graph of test results achieved using a gas sensor in accordance with the invention.

### DETAILED DESCRIPTION

The invention provides NDIR gas sensors that are particularly valuable for sensing methane. The sensors are highly selective, being able to distinguish methane from other hydrocarbons, from which can be difficult to distinguish with conventional gas sensors.

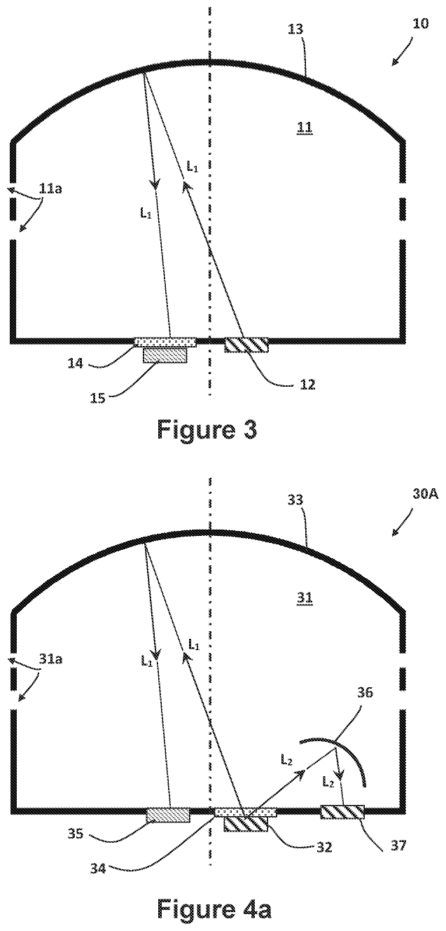

An exemplary gas sensor 10 is shown schematically in FIG. 3. The gas sensor 10 comprises a sample chamber 11 for containing a gas sample to be tested and an infrared light emitting diode (LED) 12, a first mirror 13, an infrared detector 13, a bandpass filter 14 and a first infrared detector 15.

The sample chamber 11 comprises apertures 11a through which a gas sample may enter or be introduced into the sample chamber 11. The first mirror 13 defines a portion of the boundary of the sample chamber 11.

The infrared LED 12 is configured to emit infrared radiation into the sample chamber 11. At least a portion of the radiation from the infrared LED 12 is reflected from the first mirror 13, transmitted through the bandpass filter 14 and received by the first infrared detector 15. A first optical path illustrating the passage of at least some of the radiation is shown by line L₁ in FIG. 3.

As will be seen, the first mirror 13 is curved, having a concave and substantially spherical reflecting surface. Thus, an increased proportion of radiation emitted from the LED 12 will be received by the infrared detector 15 since radiation will be focused towards the detector 15.

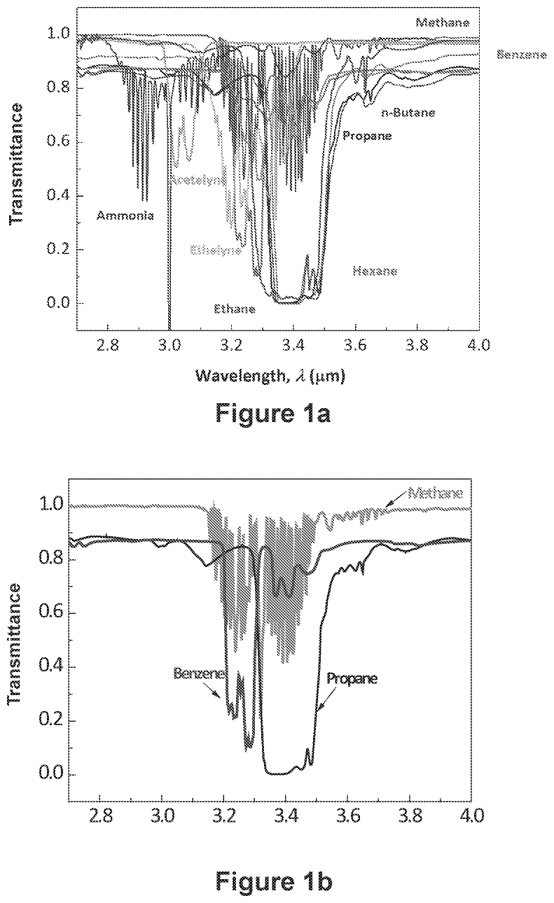

As the radiation travels along the first optical path L₁ it will interact with the contents of the sample chamber. Radiation may be absorbed, reflected, scattered, etc. by any gases present in the sample chamber 11. In particular, radiation with wavelengths in the region of 2800 nm to 4000 nm will be absorbed by hydrocarbon gases present in the sample chamber 11 as shown by the absorption spectra shown in FIG. 1.

Although the radiation emitted by the LED 12 may have a broad range of wavelengths, the bandpass filter 14 is only transmissible for radiation in a specific range of frequencies. Specifically, the bandpass filter 14 is a BP-3250-100-nm bandpass filter produced by Spectrogon Corp. (RTM) of Stockholm, Sweden. Other bandpass filters which selectively transmit radiation in a range from approximately 3150 nm to 3350 nm may alternatively be used—e.g. bandpass filters with a full width of half maximum in the range from 70 nm to 300 nm and an upper cut-off wavelength of less than or equal to 3350 nm. Further specific parameters of suitable bandpass filters are discussed above. These filters have narrow spectral ranges and transmit radiation across a range of wavelengths in which the methane absorption spectra overlaps with the absorption spectra of relatively few alterantive hydrocarbons. As such, the gas sensor 10 is highly specific to methane.

The preferred BP-3250-100-nm bandpass filter 14 has a quartz substrate, a peak wavelength (central wavelength) of 3250 nm+/−20 nm, a FWHM of 100 nm+/−nm and a maximum transmittance of at least 70%. The BP-3250-100-nm bandpass filter also meets the other requirements for suitable filters discussed above—e.g. for slope and upper and lower cut-off frequencies. Thus, the wavelengths of the acceptance band of the BP-3250-100-nm filter (across which the filter transmits light) coincides with portion of the methane absorption spectrum where methane absorbs significant proportion of infrared light. In contrast, the acceptance band of the BP-3250-100-nm filter is offset or displaced from the wavelengths at which (for instance) propane or butane absorb significant proportions of radiation. Therefore, radiation transmitted through the BP-3250-100-nm filter provides information on the presence of methane in the sample chamber 11, independent of the presence of propane or butane.

As shown, the bandpass filter 14 is arranged adjacent to the first infrared detector 15 and extends over the first infrared detector 15. As such, all radiation reaching the first infrared detector 15 from the sample chamber 11 must have been filtered by the bandpass filter 14. However, in further examples the bandpass filter 14 may extend over or around the LED 12 such that radiation from the LED 12 is filtered before it enters the sample chamber 11. Similarly, in some examples the bandpass filter 14 may extend across both the LED 12 and the first infrared detector 15 such that radiation is filtered as it is emitted and before it is received and sensed.

The first infrared detector 15 is a photodiode, for example, Asahi Kasei Microdevices sensor AK9730AJF21, although other suitable infrared detectors may also be used. The detector 15 will receive the radiation that has been transmitted through the bandpass filter 14 and is configured to convert the radiation into an output signal. This output signal is an electric signal and may correspond to the intensity of light received by the first infrared detector 15 or an averaged value the intensity of radiation received by the first infrared detector 15. As such, the output signal will be indictive of the presence and concentration of methane in the sample chamber 11 since the intensity of radiation received by the first infrared detector 15 will vary as the presence and concentration of methane changes. Therefore, the gas sensor 10 is able to selectively and accurately detect methane.

The gas sensor 10 shown in FIG. 3 is compact due to the presence of the first mirror 13. The LED 12 and the infrared detector 15 are arranged close to each other on a side of the sample chamber 11 opposing the first mirror 13. Light travelling first optical path L₁ is transmitted through the contents of the sample chamber 11 over a distance of approximately twice the height of the sample chamber 11. However, in further example no mirror may be provided and the LED 12 and infrared detector 15 may be positioned on opposing sides of a sample chamber.

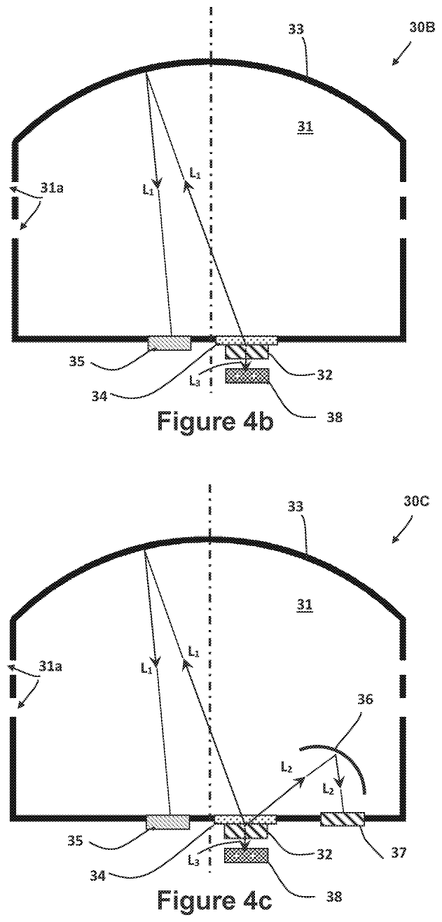

Three further gas sensors 30A, 30B, 30C are shown schematically in FIGS. 4a, 4b and 4c. These gas sensors 30A, 30B, 30C share many of the features of the gas sensor 10 shown in FIG. 3 and corresponding components have their reference signs incremented by 20 from FIG. 1. The corresponding components share the same features and advantages as the components described in reference to FIG. 3. The gas sensors 30A, 30B, 30C of FIG. 4 may be adapted to include any of the optional or preferable features discussed above with reference to FIG. 1.

The gas sensors 30A, 30B, 30C of FIG. 4a each comprise a sample chamber 31 for containing a gas sample to be tested and an infrared light emitting diode (LED) 32, a first mirror 33, a bandpass filter 34 and a first (gas signal) infrared detector 35.

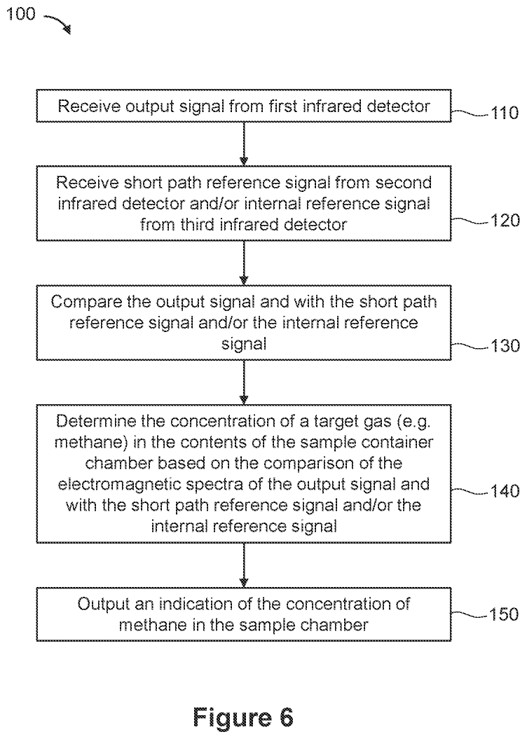

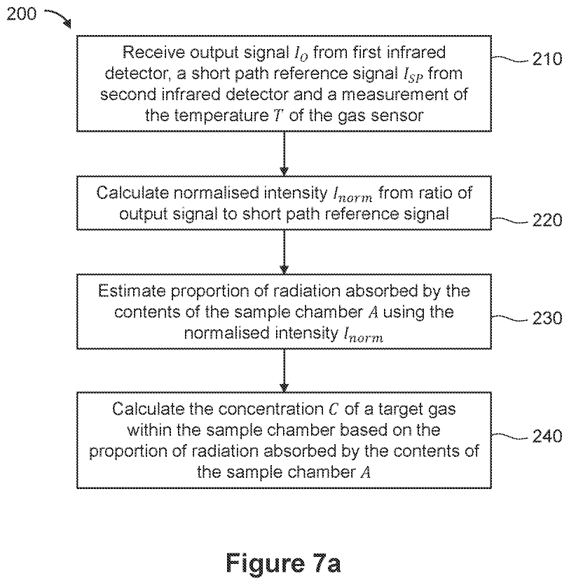

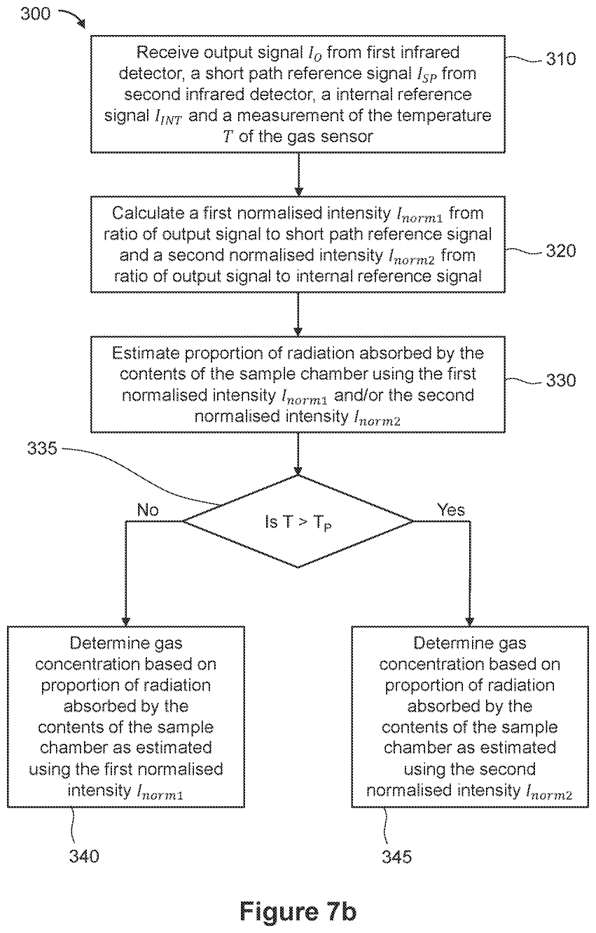

In addition, the gas sensors 30A, 30B, 30C each comprise one or more additional infrared detectors. Using these detectors, the output signal from each of these gas sensors 30A, 30B, 30C may be corrected. For examples, the output signal may be corrected or compensated for variations in environmental conditions and/or variations in the properties of the structural components of the gas sensors 30A, 30B, 30C. This correction may occur in a calibration step before use, or during use as the conditions and the properties of the gas sensor 30 change. Exemplary correction processes will be discussed below with reference to FIGS. 6 to 7.

For accurate detection of methane, the bandpass filter 34 in gas sensors 30A, 30B, 30C is the BP-3250-100-nm filter produced by Spectrogon Corp. (RTM) discussed above or another bandpass filter which selectively transmits radiation in the range from approximately 3150 nm to 3350 nm. However, it will be appreciated that other gases may also be identified using gas sensors with the structures shown in FIGS. 4a to 4c and the correction processes discussed below in reference to FIGS. 6 to 7 when alternative filters are used. For instance, alternative bandpass filters may be selected that transmit radiation across wavelength ranges corresponding to the absorption spectra of these other gases.

In more detail, the gas sensor 30A of FIG. 4A comprises a second (short path reference) mirror 36 and a second (a “short path reference”) infrared detector 37. The second mirror 36 is arranged within the sample chamber 31, whereas the second infrared detector 37 is positioned at an outer wall of the sample chamber 31 like the LED 32 and first infrared detector 35.

A portion of the radiation emitted from the infrared LED 32 of the gas sensor 30A of FIG. 4a is transmitted along a first optical path L₁ from the LED 32 to the first infrared detector 35 in the manner discussed above in reference to FIG. 3. Radiation is emitted from the LED 32, filtered by the bandpass filter 34, reflected from the first mirror 33, and received by the first infrared detector 35. The first infrared detector 35 will output a signal based on the radiation it receives. Preferably, the first infrared detector 35 outputs an output signal dependent on the intensity of radiation it receives.

In addition, a further portion of the radiation emitted from the infrared LED 32 will be transmitted along a second optical path from the LED 32 to the second infrared detector 37, as shown by line L₂ in FIG. 4a. This portion of radiation is emitted from the LED 32, reflected by the second mirror 36 and received by the second infrared detector 37. The second infrared detector 37 will output a short path reference signal based on the radiation it receives, for instance, by converting incident radiation into an electrical signal. Preferably, the second infrared detector 37 outputs a signal dependent on the intensity of radiation it receives. The second mirror 36 and second infrared detector 37 are preferably of identical or similar construction to the first mirror 33 and first infrared detector 35 respectively.

The second mirror 36 is arranged closer to the LED 32 and second infrared detector 37 than the first mirror is arranged relative to the LED 32 and the first infrared detector 35. Therefore, the second optical path L₂ is significantly shorter than the first optical path L₁. As will be seen, the second optical path L₂ is less than half the distance of the first optical path L₁. Indeed, the length of the first optical path L₁ through the sample chamber 31 and along which radiation may interact with any sample gas within the sample chamber 31 before reaching the first infrared detector 35, is significantly longer than the second optical path L₂ through the sample chamber 31. The second mirror 36 is again curved so as to focus reflected light to the second infrared detector 37. However, this is not essential and in other examples the second mirror 36 may take other forms—e.g. being flat.

Radiation travelling along the shorter second optical path L₂ will be less affected by the contents of the sample chamber 31 than the radiation travelling along the first optical path L₁. In other words, radiation received by the second infrared detector 37 will have been less absorbed by any methane (or another target gas when an alternative filter is used) present in the sample chamber 31. In comparison to the output signal produced by the first infrared detector 35, the short path reference signal output by the second detector 37 will contain relatively less information regarding the contents of the sample chamber 31 to the information a greater proportion of information regarding the properties of the LED 32, the mirrors 33, 36 and other structural components of the gas sensor 30. These properties will typically vary with environmental conditions, with the age of the gas sensor and between different gas sensors due to minor variations in manufacturing. The output signal from the first infrared detector 35 may be corrected for variations in these properties using the short path reference signal from the second infrared detector 37.

The gas sensor 30B of FIG. 4B comprises a third (an “internal reference”) infrared detector 38 instead of the second (“short path reference”) infrared detector 37 shown in FIG. 4A.

A portion of the radiation emitted from the infrared LED 32 of the gas sensor 30B of FIG. 4b is transmitted along a first optical path L₁ from the LED 32 to the first infrared detector 35 in the manner discussed above in reference to FIGS. 3 and 4a. The first infrared detector 35 produces an output signal based on the radiation it receives. In addition, a further portion of the radiation emitted from the infrared LED 32 will be transmitted along a third optical path from the LED 32 to the third infrared detector 38 as shown by line L₃ in FIG. 4b. The third infrared detector 38 will output an internal reference signal based on the radiation it receives, for instance, by converting incident radiation into an electrical signal. The internal reference signal may be dependent on the intensity of the radiation received by the third infrared detector 38. The third infrared detector 38 is preferably of identical or similar construction to the first infrared detector 35.

The third infrared detector 38 and LED 32 are arranged such that the third optical path L₃ does not extend through the sample chamber 31. As shown, the third infrared detector 38 is positioned on the opposing side of the LED 32 from the sample chamber 31, although this is not essential. The third infrared detector 38 is provided adjacent to the LED 32 such that the third optical path L₃ is significantly shorter than the first optical path L₁. For instance, the first optical path L₁ may be at least 5 times or at least 10 times longer than the distance of the third optical path L₃.

Radiation travelling along the third optical path L₃ will not be affected by the contents of the sample chamber 31. Instead of information regarding the contents of the sample chamber 31, the internal reference signal will primarily contain information regarding the function of the LED 32. For instance, using the internal reference signal it is possible to identify the effect of environmental conditions and age on the LED 32 or to identify differences between different LEDs 32 used in different sensors. Therefore, the output signal from the first infrared detector 35 may be corrected or adjusted for these effects using the internal reference signal from the third infrared detector 38.

In further specific examples the third optical path L₃ may extend through an internal chamber (not shown) of the gas sensor 30B that is positioned between the LED 32 and the third infrared detector 38. The internal chamber may be sealed such that it does not contain any of the sample gas present in the sample chamber. The internal chamber may comprise a gas transmissive to infrared radiation across the wavelengths of interest (e.g. the wavelengths of the acceptance band of the bandpass filter, approximately 3100 nm to 3400 nm) and/or be held under vacuum. Equally, the third infrared detector 38 may be provided in contact with the LED 32. In these examples, radiation travelling along the third optical path L₃ is not absorbed, reflected or scattered significantly before reaching the third infrared detector 38. Therefore, the radiation reaching the third infrared detector 38 is particularly accurate to the output of the LED and has not interacted with or passed through any sample within the sample chamber 31.

FIG. 4c shows a further gas sensor 30C that comprises both the second mirror 36 and the second infrared detector 37 from the sensor 30B shown in FIG. 4b and the third infrared detector 38 from the sensor 30B shown in FIG. 4c. These components comprise corresponding features, operate in corresponding manners and offer corresponding advantages as the features present in the gas sensors 30A, 30B of FIGS. 4a and 4b. The short path reference signal from the second infrared detector 37 and the internal reference signal 38 may be used to adjust or correct the output signal from the first infrared detector 35 of the gas sensor 30C of FIG. 4C.

Unlike the gas sensor 10 illustrated in FIG. 3, a bandpass filter 34 in each of the gas sensors 30A, 30B, 30C in FIGS. 4a to 4c is arranged across the LED 32 rather than the first infrared detector 35. As such, all radiation emitted from the LED 32 is filtered by the bandpass filter 34 before entering the sample chamber 31 such that only radiation with wavelengths corresponding to the acceptance band of the bandpass filter 34 reach the infrared detectors 35, 37. However, it will be appreciated that this is not essential. For example, in further examples a bandpass filter may be provided over or across all of the infrared detectors or separate bandpass filters may be provided that extends across the different detectors.

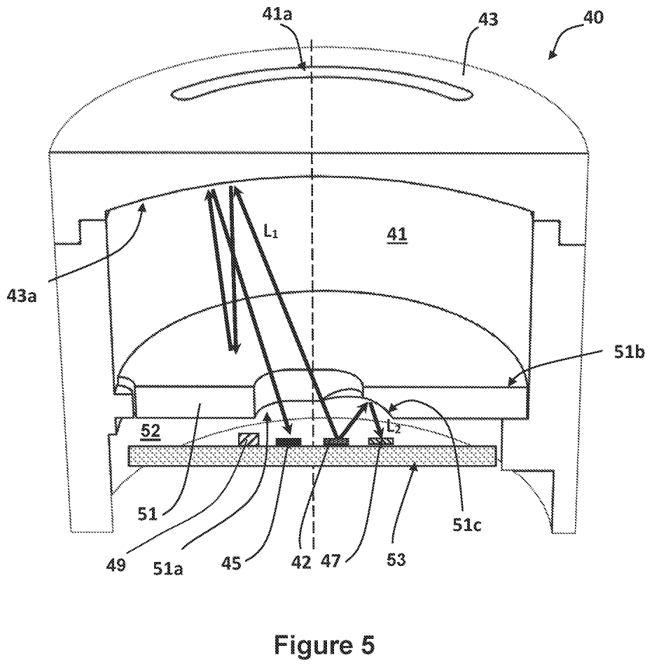

FIG. 5 shows a further gas sensor 40 that operates on similar principles to the examples discussed above. Reference signs for similar components have been incremented by 30 from FIGS. 3, and 10 from FIG. 4.

The gas sensor 40 is broadly cylindrical (although this is not essential) and comprises a sample chamber 41 for containing a sample defined by a cylindrical outer wall 41, a concave mirror 43, and a planar mirror 51. The planar mirror 51 and concave mirror 43 are positioned at opposing ends of the cylindrical outer wall 41.

The concave mirror 43 closes one end of the sample chamber 41 (the upper end as shown). Specifically, the concave mirror 43 is spherical, such that its internal surface 43a defines a portion of a sphere, although other shapes may also be possible. The concave mirror 43 comprises an aperture 41a through which gas may enter the sample chamber 41.

The planar mirror 51 closes the opposing end of the sample chamber 41, comprising a substantially planar reflecting surface 51b that defines one end of the sample chamber 41. The planar mirror 51 comprises a central aperture 51a through which radiation may pass.

The gas sensor 40 further comprises an infrared LED 42, a first (gas signal) infrared detector 45 and a second (short path) infrared detector 47. The LED 42 and the infrared detectors 45, 47 are arranged outside the sample chamber 41, below the planar mirror 51. The first infrared detector 45 is configured to produce an output signal based on the radiation it receives. Whereas the second detector 47 produces a short path reference signal based on the radiation it receives.

The LED 42 comprises an integral bandpass filter, such that all radiation emitted from the LED 42 is transmitted through the bandpass filter. For instance, to accurately detect methane, the bandpass filter may be arranged to transmit radiation within a range of approximately 3100 nm to 3350 nm but to prevent transmission of radiation outside this range. This range extends over wavelengths in which methane absorbs significant amounts of radiation, but various other common hydrocarbons such as propane do not. For instance, the bandpass filter may again be a BP-3250-100-nm bandpass filter produced by Spectrogon Corp. (RTM) of Stockholm, Sweden. However, in further examples the filter may be chosen to selectively transmit light in a range where a different target gas absorbs significant amounts of radiation.

Directly below the aperture 51a in a sensing chamber 52 are arranged the infrared LED 42 and the first infrared detector 45. The LED 42 is arranged to emit radiation into the sample chamber 41 through the aperture 51a and the first infrared detector is arranged to receive radiation that passes through the aperture 51a from the sample chamber 41. In addition, as shown by first optical path L₁, in FIG. 5, the mirrors are configured such that, at least a portion of the radiation (light) emitted from the LED 42 enters the sample chamber 41 through the aperture 51a, and is reflected from the concave mirror 43, reflected from the planar reflecting surface 51b of the planar mirror 51, reflected a second time from the concave mirror 43 and focused upon the first defector 45.

Thus, in the gas sensor 40 shown in FIG. 5 the radiation travels a distance through the sample chamber 41 along the first optical path L₁ that is approximately double the distance that radiation travels along the equivalent optical path in the examples in FIGS. 3 and 4. The length of the first optical path L₁ between the LED 42 and first infrared detector 45 is approximately doubled in this example. This increases the sensitivity of the sensor by a factor of two (approximately) since the radiation travelling along the first optical path L₁ will interact with the contents of the sample chamber for longer.

The planar mirror 51 further comprises a second reflecting surface 51c (a second mirror) arranged on its underside, its underside being the side opposing the planar surface 51a. The LED 42 and second infrared detector 47 are arranged such that a portion of the radiation from the LED 47 is reflected from the second reflecting surface 51b to the second infrared detector 47. This is shown by the optical path L₂, which is significantly shorter than the first optical path L₁.

Although gas may pass through the aperture 51a from the sample chamber 51 to the sensing chamber 52 in which the LED 42 and infrared detectors 45, 47 are positioned, radiation travelling along the second optical path L₂ to the second infrared detector 47 will be significantly less affected by any gas within the gas sensor than the radiation travelling the first optical path L₁. In comparison to the output signal produced by the first detector 45, the short path reference signal produced by the second detector 47 will contain relatively less information regarding the contents of the sample chamber 41 and will contain a higher proportion of information regarding the properties of the LED 42 and planar mirror 51. As with the previous examples, the output signal from the first detector 45 may be corrected or compensated for variations in the properties of the structural components of the gas sensor 40 using the short path reference signal.

The gas sensor 40 shown in FIG. 5 further comprises an environmental sensor 49 for sensing the conditions of the sensor. For instance, the environmental sensor may comprise a thermistor or other temperature sensor and/or a hygrometer or other humidity sensor. As shown, the environmental sensor 49 is located in the sensing chamber 52 so that it may provide an accurate measurement of the conditions local to the LED 42 and infrared detectors 45, 47. Indeed, preferably the environmental sensor 49 is located close to (e.g. adjacent or in contact with) the LED 42 and/or any infrared detector(s). However, this is not essential and in further examples an environmental sensor 49 may be located elsewhere. The environmental sensor 49 may be configured to provide a sensing result based on its local environmental conditions. This sensing result may be used to compensate or correct the output signal from the gas sensor 40.

The LED 42, infrared detectors 45, 47 and environmental sensor 49 are mounted on a substrate 52. The substrate 52 may be a smaller outline integrated circuit (SOIC) or a printed circuit board (PCB). The LED 42 may be an LED chip and the photodetectors 45, 47 may be photodetector chips. These chips may be easily mounted to other electronic components.

Thus, it will be seen that the gas sensor 40 shown in FIG. 5 shares broad architectural similarities with the gas sensor of FIG. 3a which also includes a second mirror 36 and a second infrared detector 37. When compared to the example in FIG. 3a, it will be seen that the LED 42 and infrared detectors 54, 47 of the gas sensor 40 of FIG. 5 are contained within a sensing chamber 52 and are separated from sample chamber by the planar mirror 51. In addition, the gas sensor 40 of FIG. 5 includes the environmental sensor discussed above.

The features of the gas sensor 40 in FIG. 5 may be combined with any of the gas sensors previously described. Indeed, the features of the gas sensors in FIGS. 3 to 5 may be combined in any suitable combination. For example, the gas sensor 40 of FIG. 5 may in some examples be provided with a third (internal) infrared detector similar to the example of FIG. 4c. Equally, environmental sensors may be provided to the examples discussed above with reference to FIGS. 3 and 4 or the optical components of the gas sensors shown in FIGS. 3 and 4 may be provided in a sensing chamber that is separate from the sample chamber.

Methods of handling the signals produced by the gas sensors of FIGS. 4 to 5 will now be discussed with reference to FIGS. 6 and 7. These gas sensors include one or more infrared detectors arranged to produce reference signals which can be used to correct an output signal from the gas sensor.

When used with the gas sensors discussed above with reference to FIGS. 4 to 5, which include a bandpass filter with an acceptance band selected for methane, the methods may be used to determine the concentration of methane in the contents of the sample chamber. However, it will be appreciated that the methods may be used to determine the concentration of other gases when used with gas sensors with alternative bandpass filters selected for other target gases.

The methods may be performed by a processor. For instance, the methods may be performed by a processor within any of the gas sensors discussed above or within an external controller. For instance, the gas sensor may be configured to transmit the signals produced by their infrared detectors to a remote controller.

FIG. 6 is a flow chart explaining an exemplary method 100 to calculate concentrations of gases using the signals produced by the gas sensors discussed above with reference to FIGS. 4 and 5. The method corrects or compensates for many major sources of error, including: temperature dependence of the LED-receiver transmittance, aging of the filter and aging of the mirror surfaces.

In step 110 the processor receives an output signal from the first infrared detector. Whilst in step 120 the processor receives a short path reference signal from second infrared detector and/or an internal reference signal from third infrared detector. These signals may be instantaneous, continuous or averaged over a suitable time period. The signals may be received over a wired or wireless connection.

Optionally, where the gas sensor comprises an environmental sensor, the processor may also receive environmental data from an environmental sensor. For example, the processor may receive a temperature signal from a temperature sensor indicating the ambient temperature of the gas sensor.

The signals from the infrared detectors and any environmental sensors may be analog or digital. Where the signals are analog signals the method may include an optional step in which the signal or signals are converted to digital form using one or more analog to digital convertors (ADCs). Various known ADCs may be used for this step.

In step 130 the processor compares the output signal and with the short path reference signal and/or the internal reference signal. The comparison of the output signal to one or more of the reference signals enables the effects of the contents of the sample chamber on the output signal to be isolated from the effects of (for instance) changing environmental conditions and/or changes in the properties of the LEDs, mirrors and other components of a sensor over time.

For example, the processor may calculate a first ratio between the output signal and the short path reference signal. Additionally or alternatively, the processor may calculate a second ratio between the output signal and the internal reference signal. These ratios form a normalised output signal. For instance, where the output signal and reference signal or signals are intensities, the ratio between the output signal and a reference signal is a normalised intensity value. The normalised output signal is an indication of the proportion of the output signal produced by the first infrared detector that is caused by the contents of the sample chamber, as opposed to other factors.

Alternatively, the processor may calculate a difference between the output signal and the short path reference signal and/or the internal reference signal. The difference is an indication of the amount of the output signal that is not caused by the contents of the sample chamber. The processor may then remove this difference from the output signal to generate an adjusted output signal that better represents the effects of the contents of the sample chamber on the radiation emitted by an LED.

In step 140 the processor determines the concentration of a target gas (e.g. methane when using one of the gas sensors discussed above) in the contents of the sample chamber based on the comparison of the electromagnetic spectra of the output signal and the short path reference signal and/or the internal reference signal.

For instance, from the normalised or adjusted output signal, the processor may calculate the proportion of light emitted by the LED that has been absorbed by the contents of the sample chamber. In turn, using the absorption, the processor can determine the concentration of the target gas (e.g. methane) in the contents of the sample chamber. Alternatively, the processor may determine the concentration of a target gas (e.g. methane) directly from the normalised or adjusted output signal(s).

The determination may be based on a predetermined mathematical function or a look up table which relates the absorption or the normalised or adjusted output signals with concentration. These functions or tables may be set by a manufacturer of the gas sensor or a user. The relationships between gas concentration and the normalised or adjusted output signal may be determined based on theoretical models or empirically by investigating values output by the gas sensor when exposed to known concentrations of the target gas.

The determination of the concentration of the target gas (methane) produced by the processor may additionally be based on environmental conditions. For instance, the determination may be based on a temperature measurement received from a temperature sensor. Two specific methods using temperature measurements will be discussed below with reference to FIGS. 7a and 7b.

Having determined the concentration of the target gas (e.g. methane), in step 150 the processor outputs an indication of the concentration of the target gas in the sample chamber as measured by the gas sensor. The indication may be presented to a user by an output device. For example, the processor may instruct a screen, display or one or more lights to provide a visual indication of the concentration of the target gas to a user. Equally, processor may instruct a speaker or other audio output device to provide an audio indication of the concentration of the target gas to a user.

The indication may be provided continuously, periodically, in response to the concentration of the target gas (e.g. methane) exceeding a predetermined level or dropping below a predetermined level, or in response to a request or input from a user. Additionally or alternatively, the processor may be configured to store the measurements in storage and/or to transmit the concentration to a remote device for storage, monitoring or processing of the measured data. This transmission may occur over a network (e,g. the internet).

The concentration of the target gas calculated through the method 100 of FIG. 6 provides increased accuracy as the comparison between the output signal and the short path reference signal and/or the internal reference signal compensates for or removes aspects of the output signal that are not caused by the absorption of radiation within the sample gas chamber.

FIGS. 7a and 7b show flow charts that describe methods 200, 300 of determining gas concentration using normalised output signals and temperature measurements. The methods offer improved accuracy and compensation for changes in temperature. These methods can be seen as specific examples of steps 110 to 140 of FIG. 6.

The method 200 shown FIG. 7a may be performed based on the signals from a gas sensor that comprises a first (output) infrared detector and a second (short path reference) infrared detector such as in the examples shown in FIGS. 4a, 4c and 5. The method is able to accurately compensate for the effects of changing temperature. The optical path between an LED and the first (output) infrared detector is longer than the optical path between the LED and the second (short path reference) detector.

In step 210 the processor receives an output signal I_{O} from a first infrared detector and a short path reference signal I_{SP} from a second infrared detector. This is equivalent to steps 110 and 120 discussed above with reference to FIG. 6 and shares any of the previously described features and benefits. The output signal I_{O} and a short path reference signal I_{SP} correspond to the intensity of the light incident on the respective detector. In addition, the processor receives a measurement of the temperature T of the gas sensor. The temperature measurement may be of an ambient temperature around the gas sensor or the temperature measured within the gas sensor. As such, the temperature measurement may be received from a temperature sensor within the gas sensor or a separate temperature sensor.

If any of the received signals or measurements are analog signals, the processor may optionally convert them to a digital form using an analog to digital convertor (ADC).

In step 220, the processor calculates a normalised intensity Iₙₒᵣₘ from a ratio of the output signal I_{O} to the short path reference signal I_{SP}:

$$\\ {I}_{norm} = \frac{{I}_{O}}{{I}_{SP}}$$

Assuming the first and second infrared detectors have similar construction and similar amounts of radiation reach each infrared detector, then the normalised intensity Iₙₒᵣₘ will be approximately equal to 1 if the contents of the sample chamber do not significantly absorb infrared radiation in in the region of interest. This may occur in the specific gas sensors discussed above with reference to FIGS. 3 to 5 if no methane is present. In contrast, if radiation passing through the sample chamber is absorbed by the contents of the sample chamber the output signal I_{O} will have a lower value of intensity and Iₙₒᵣₘ will have a value lower than 1. Therefore, if the normalised intensity Iₙₒᵣₘ is less than 1, it is indicative that the target gas (e.g. methane) is present in the sample chamber. It will be appreciated that step 220 is a specific example of step 130 as discussed above with reference to FIG. 6.

In step 230, the processor estimates the proportion of radiation absorbed by the contents of the sample chamber A using the normalised intensity. For instance, the processor may calculate the proportion of radiation absorbed by the contents of the sample chamber A as the inverse of the normalised intensity:

$$\\ A = 1 - {I}_{norm}$$

An alternative, more accurate estimate may be obtained using a baseline normalised intensity I_{baseline}. The baseline normalised intensity I_{baseline}. is a value for the normalised intensity that would be expected when the sample chamber is empty (i.e. when the target gas is not present).

In general, the baseline normalised intensity I_{baseline} might be expected to be approximately equal to 1 when the sample chamber is empty, the first and second infrared detectors are of similar construction and they receive similar amounts of radiation from the LED. However, the true value for the baseline normalised intensity I_{baseline} will vary with the construction of the gas sensor (e.g. due to differences between the first and second infrared detectors) and/or environmental conditions. The baseline normalised intensity I_{baseline} is preferably predefined. For instance, it may be set by a manufacturer or recorded during a calibration process performed using the gas sensor.

Thus, the processor may approximate the proportion of radiation absorbed by the contents of the sample chamber A through the equation:

$$\\ A = {I}_{baseline} - {I}_{norm}$$

Preferably, the baseline normalised intensity I_{baseline} is a function dependent on the temperature T—i.e. the baseline normalised intensity may be represented as I_{baseline}(T). This function may be developed empirically through a testing or calibration process or from a theoretical model. The baseline normalised intensity I_{baseline}(T) may be stored by the processor as a mathematical expression or as a series of values (e.g. in a lookup table). Using a baseline normalised intensity I_{baseline}(T) that is dependent on temperature T is particularly accurate as the calculation of absorption will vary dependent on the effects of temperature. As temperature T changes the optical properties of LEDs, infrared detectors and mirrors will change. The baseline normalised intensity I_{baseline}(T) will change with these parameters, thereby maintaining accuracy. Therefore, the calculation for the proportion of radiation absorbed by the contents of the sample chamber A can be rewritten as:

$$\\ A = {I}_{baseline} ( T ) - {I}_{norm}$$

In step 240, the processor calculates the concentration C of a target gas within the sample chamber based on the proportion of radiation absorbed by the contents of the sample chamber A.

The concentration C of the target gas may be calculated using a gas calibration function G(A):

$$\\ C = G ( A )$$

The gas calibration function G(A) is predefined. For instance, the function may be set by a manufacturer or recorded during a calibration process performed using the gas sensor in question or a sample gas sensor. The gas calibration function G(A) may be developed empirically through a testing or calibration process in which the response of gas sensors to known concentrations of a target gas is assessed. Alternatively, the function may be determined from a theoretical model The gas calibration function G(A) may be stored by the processor as a mathematical expression or as a series of values (e.g. in a lookup table).

In further examples, a similar method to the example shown in FIG. 7a may be performed using an internal reference signal I_{INT} in place of the short path reference signal I_{SP}. Corresponding calculations to the examples discussed may be performed using the internal reference signal I_{INT}. Corresponding values for the baseline normalised intensity and gas calibration function may be developed.

FIG. 7b shows a further method 300 which may be performed using signals from a gas sensor that comprises a first (output) infrared detector and both a second (short path reference) infrared detector and a third (internal reference) infrared detector. The method is able to compensate for the effects of changing temperature particularly accurately.

In step 310 the processor receives an output signal I_{O} from a first infrared detector, a short path reference signal I_{SP} from a second infrared detector and an internal reference signal I_{INT} from a third infrared detector. This is equivalent to steps 110 and 120 discussed above with reference to FIG. 6 and step 210 of the method of FIG. 7a. As such, step 310 shares any of the previously described optional features and benefits of these steps.

The output signal I_{O}, short path reference signal I_{SP} and internal reference signal I_{INT} correspond to the intensity of the light incident on the respective detectors. In addition, the processor receives a measurement of the temperature T of the gas sensor. The temperature measurement may be of an ambient temperature around the gas sensor or the temperature within the gas sensor. The temperature measurement may be received from a temperature sensor within the gas sensor or a separate temperature sensor.

Again, if any of the received signals or measurements are analog signals, the processor may optionally convert them to a digital form using an analog to digital convertor (ADC).

In step 320, the processor calculates two normalised intensity values. Each calculation corresponds to the calculation discussed above in reference to step 220 of FIG. 7a. The first normalised intensity Iₙₒᵣₘ₁ is a ratio of the output signal I_{O} to the short path reference signal I_{SP}:

$$\\ {I}_{norm 1} = \frac{{I}_{O}}{{I}_{SP}}$$

It will be appreciated that the first normalised intensity Iₙₒᵣₘ₁ may be substantially equivalent to the normalised intensity Iₙₒᵣₘ discussed with reference to FIG. 7a.

The second normalised intensity Iₙₒᵣₘ₂ is calculated from a ratio of the output signal I_{O} to the internal reference signal I_{INT}:

$$\\ {I}_{norm 2} = \frac{{I}_{O}}{{I}_{INT}}$$

Where the sample chamber is empty of the target gas, Iₙₒᵣₘ₂ will typically be lower than Iₙₒᵣₘ₁. This is because in most arrangements, the radiation reaching the third (internal) infrared detector will have travelled a shorter distance and interacted with fewer components of the gas sensor as it is transmitted from the LED to the third infrared detector when compared to the radiation incident on the second (short path) infrared detector. Therefore, the internal reference signal I_{INT} will tend to be greater in value that the short path reference signal I_{SP}.

In step 330, the processor estimates the proportion of radiation absorbed by the contents of the sample chamber using the first normalised intensity Iₙₒᵣₘ₁ and/or the second normalised intensity Iₙₒᵣₘ₂.

For instance, the processor may calculate two approximations for the proportion of radiation absorbed by the contents of the sample chamber A through the equations:

$$\\ {A}_{1} = {I}_{baseline 1} - {I}_{norm 1} and : {A}_{2} = {I}_{baseline 2} - {I}_{norm 2}$$

Where I_{baseline1} and I_{baseline2} are predefined baseline values for the normalised intensity as calculated using the short path reference signal and the internal reference signal respectively. Each of these calculations is analogous to the steps discussed above with reference to step 230 in FIG. 7a. Indeed, A₁ may be identical to A as calculated in step 230. The baseline normalised intensity values I_{baseline1} and I_{baseline2} may be constant. Alternatively, they may be functions of temperature, as discussed above with reference to step 230. That is, I_{baseline1} and I_{baseline2} may be rewritten as I_{baseline1}(T) and I_{baseline2}(T).

Calculating two separate estimates for absorbance enables improved accuracy over a greater temperature range. The processor may use both values to determine the concentration of a target gas (e.g. methane) in the sample chamber of a gas sensor.

In the example shown in FIG. 7b, the processor uses the different values for absorbance A₁, A₂ dependent on the temperature T of the gas sensor. When the temperature T of the gas sensor is less than or equal to a predetermined transition temperature T_{P} the processor uses the absorbance A₁ calculated using the short path reference signal. Whereas if the temperature T of the gas sensor is greater than the predetermined transition temperature T_{P} the processor uses the absorbance A₂ calculated using the internal reference signal.

In step 335, the process compares the current temperature T of the gas sensor to the transition temperature T_{P}.

If the temperature is less than or equal to the transition temperature T_{P}, then in step 340 the processor calculates the concentration C of a target gas within the sample chamber based on the proportion of radiation A₁ absorbed by the contents of the sample chamber as estimated using the short path reference signal. The concentration C of the target gas may be calculated using a first gas calibration function G₁ (A₁):

$$\\ C = {G}_{1} ( {A}_{1} )$$

This approach is analogous to the approach using the gas calibration function G(A) discussed above with reference to step 240 of FIG. 7a. It is particularly accurate since the short path reference signal I_{SP} on which the calculations are based contains information regarding the optical properties of the LED, bandpass filter and any mirrors in the gas sensor. However, the precision or reproducibility of measurement using this calculation can drop as temperature increases.

The reduction in precision at high temperatures is caused by because of the effects of temperature on the optical components of the gas sensor, in particular the LED. As temperature increases, the emission spectra of LEDs flattens, such that their peak emission and the total intensity of the emitted light are reduced. Thus the overall intensity of radiation emitted by LEDs is reduced. In addition, the emission spectra of LEDs undergo a frequency shift, moving to higher frequencies.

Consequently, as temperature increases the amount of radiation incident on the infrared detectors in the gas sensors discussed above will be reduced. The output signal I_{O} from the first infrared detector, the short path reference signal I_{SP} and the internal reference signal I_{INT} will reduce as temperature increases.

The reduction in the overall amount of radiation emitted by the LED affects all three signals. However, the frequency shift disproportionally affects the output signal I_{O} and the short path reference signals I_{SP} in the gas sensors discussed above since radiation reaching the respective infrared detectors must pass through a bandpass filter.

The intensity of radiation passing through the bandpass filter and arriving at the first (output) and second (short path) infrared detectors is reduced as temperature increases because the LED emission spectra becomes “detuned” relative to the acceptance band of the bandpass filter. During the design process, an LED is typically selected such that at a nominal, design temperature the LED emission spectrum has a peak emission wavelength that is approximately the same as the peak wavelength of the bandpass filter. As such, the emission spectrum of the LED and the transmission spectrum of the bandpass filter will overlap significantly at the design temperature. As such, large amounts of radiation emitted by the LED will pass through the bandpass filter and reach the infrared detector at the design temperature. Whereas, as temperature increases, the LED emission spectra will move to higher frequencies. Consequently the peak emission wavelength of the LED will diverge from the peak wavelength of the bandpass filter. Therefore, the overlap of the two spectra will reduce, and less radiation will be transmitted through the bandpass filter to the first and second infrared detectors regardless of the contents of the sample chamber.

It should be noted that although the magnitude of the output signal I_{O} from the first infrared detector and the short path reference signal I_{SP} will be reduced as temperature increases, their ratio—the first normalised intensity Iₙₒᵣₘ₁ (Or Iₙₒᵣₘ as discussed above in reference to FIG. 7a)—will remain substantially constant on average. However, the signal to noise ratio in the signals I_{O}, I_{SP} and in the first normalised intensity Iₙₒᵣₘ₁ will increase with temperature. As signal to noise ratio increases, the precision or reproducibility of the measurement of concentration C is decreased.

To maintain precision, if the temperature is determined to be above the predetermined transition temperature T_{P} in step 335, the processor calculates the concentration C of a target gas within the sample chamber based on the proportion of radiation A₂ absorbed by the contents of the sample chamber as estimated using the internal reference signal and second normalised intensity Iₙₒᵣₘ₂. This is shown in step 345.

Higher precision is achieved at high temperatures using the second estimate for the proportion of radiation A₂ because the second normalised intensity Iₙₒᵣₘ₂ will tend to have a lower signal to noise ratio than the first normalised intensity Iₙₒᵣₘ₁. This is because the internal reference signal I_{INT} will contain less noise than the short path reference signal I_{SP} since its magnitude is not affected by the frequency shift of the emission spectra of the LED and the “detuning” that occurs the LED and the first and second infrared detectors.

For example, in step 345, the concentration C of the target gas may be calculated using a second gas calibration function G₂(A₂):

$$\\ C = {G}_{2} ( {A}_{2} )$$

Therefore, it will be understood that at temperatures above the transition temperature T_{P} the method 300 trades the particularly high accuracy possible using a calculation based on the short path reference signal I_{SP} (and first normalised intensity Iₙₒᵣₘ₁) for the increased precision offered by a calculation based on the internal reference signal I_{INT} (and second normalised intensity Iₙₒᵣₘ₂). Nevertheless, the calculation based on the internal reference signal I_{INT} and second normalised intensity Iₙₒᵣₘ₂ still retains good accuracy since the internal reference signal I_{INT} contains information about the LED for which the measurement is compensated for.

The predetermined transition temperature T_{P} is preferably set by the manufacturer of the gas sensor (although this is not essential). The transition temperature T_{P} may in be the range of 15 to 40 degrees Celsius greater than the nominal, design temperature of the gas sensor and more preferably is in the range of 20 to 30 degrees Celsius greater. The inventors have identified for gas sensors intended to measure methane, such as the examples discussed above with reference to FIGS. 3 to 5, strong performance is achieved at higher temperatures when the transition temperature T_{P} is set in the range of 35 to 55 degrees Celsius, more preferably in the range of 40 to 50 degrees Celsius, more preferably still is 45 degrees Celsius or approximately 45 degrees Celsius. This value has been determined by the inventors provides a strong balance between precision and accuracy at high temperatures (e.g. up to and above 65 to 75 degrees Celsius).

The first and second gas calibration functions G₁(A₁) and G₂(A₂) are preferably predefined. The functions may be set by a manufacturer or recorded during a calibration process performed using the gas sensor in question or a sample gas sensor. As such, the functions may be developed empirically through a testing or calibration process or from a theoretical model. The gas calibration functions G(A₁) and G₂(A₂) may be stored by the processor as a mathematical expression or as a series of values (e.g. in a lookup table).

Although the first and second gas calibration functions used in steps 240 and 245 may be different. In some examples the first and second gas calibration functions are be identical—i.e. G₁(A)=G₂(A).

In addition to the specific methods 200, 300 discussed above with reference to FIGS. 7a and 7b it will be appreciated that a variety of alternative methods for determining gas concentrations will be possible using the signals produced by the gas sensors discussed above. Equally, a variety of methods of signal correction and adjustment are possible using the reference signals discussed above. For example, in some examples the processor may calculate a concentration of a target gas using the mean or a weighted average of different estimates for the proportion of radiation A₁, A₂ absorbed by the contents of the sample chamber produced in step 330. Similarly, the processor may calculate concentration of the target gas using a gas calibration function G that is dependent on both values of absorbance A₁, A₂—i.e. G(A₁, A₂).

Following the methods 200, 300 of FIGS. 7a and 7b an indication of the concentration may be output to a user or an external system as discussed with reference to step 150 of FIG. 6.

In further examples of signal correction, the internal reference signal produced by a third (internal) infrared detector may be used to generate a temperature offset coefficient. The internal reference signal from the third (internal) infrared detector is only affected by the infrared emission power of the LED and the sensitivity of the second reference detector 38, rather than the contents of the sample chamber. As such, a processor may set a temperature offset coefficient which varies depending on the variations in the internal reference signal This temperature offset coefficient may be used to correct or adjust both the output signal and the short path reference signal in order to account for the effects of temperature on the LED and first and second infrared detectors. Subsequently, variations in the temperature-corrected short path reference signal may be used to generate a second offset coefficient that accounts for the filter temperature dependence and aging (reflectivity change) of mirrors within the gas sensor. The temperature-corrected output signal from the infrared detector may be adjusted by this second offset. The resulting signal—a modified version of the output signal which has been temperature-corrected and age-corrected—may be used to calculate the concentration of gas within the sample chamber. For instance, a process may use a predetermined function to calculate the concentration of gas within the sample chamber from the corrected output signal.

Preferably, the method is performed based on the signals detected by the gas sensors discussed above that comprise a first infrared detector that produces an output signal, a second infrared detector that produces a short path reference signal and a third infrared detector that produces an internal reference signal. As such, the method preferably further comprises the steps of: receiving the internal reference signal from the third infrared detector; comparing the internal reference signal to the output signal or the short path reference signal to identify properties of one or more of the bandpass filter, the first mirror and the second mirror; and wherein determining the concentration of methane in the sample chamber is further based on the comparison of the electromagnetic spectra of the internal reference signal and the output signal or the comparison of the internal reference signal and the short path reference signal.

It will be appreciated that the benefits of the signal correction methods described above are not limited to gas sensors comprising any specific bandpass filter—i.e. the benefits of this method are not limited to examples of gas sensors using the bandpass filters for the detection of methane discussed above. Indeed, this method could be applied for results obtains from substantially any gas sensors that produce an output signal, a short path reference signal and an internal reference signal. These gas sensors could be provided with a wide range of filters in place of the specific bandpass filters discussed above. In other words, the gas sensors discussed above with reference to FIGS. 4 and 5 could be adapted or modified to include alternative filters in place of a specific bandpass filter chosen such that the gas sensor can detect methane.

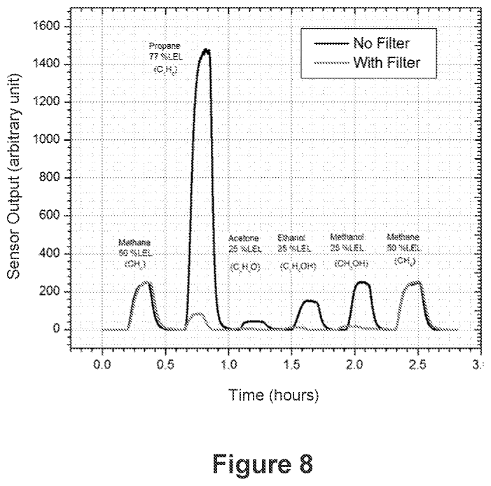

The improved performance of gas sensors in accordance with the invention for detecting methane will now be discussed in reference to FIG. 8. This figure shows the output of two gas sensors over time. The two gas sensors include a first, comparative gas sensor that does not comprise a bandpass filter and a second gas sensor that includes a bandpass filter in accordance with the invention with a relatively narrow acceptance band with a peak value at approximately 3250 nm.

The two gas sensors were sequentially exposed to methane and a series of interfering gases. Specifically, the gas sensors were exposed across a period of approximately 3 hours to: Methane at 50% of its Lower Explosive Limit (LEL); Propane at 77% LEL; Acetone 35% LEL; Ethanol at 25% LEL, Methanol at 25% LEL; and finally Methane again at 50% of its LEL.

It will be seen that the first, comparative gas sensor without a filter provides a significant response to each of the hydrocarbon gases. Whilst this may be desirable if the gas sensor is intended to provide an alert for the presence of any flammable or explosive gases it is not suitable when attempting to distinguish Methane from other hydrocarbons. From the response of the comparative sensor it is not possible to determine which gas is present.

In contrast, the second gas sensor in accordance with the invention provides strong responses when methane is present but low or negligible outputs in response to the other interfering gases. In particular, the response to propane is reduced by approximately a factor of 10. Therefore, gas sensors in accordance with the invention provide a more accurate and more selective means for methane detection than was previously possible.

As shown in FIG. 8 the gas sensor and any processor therein may be configured to provide an output indicating a measured over time. This output may be updated periodically or continuously. Alternatively the sensor output can be generated on demand—e.g. in response to a request from a user or external components of a wider system.

The gas sensor may comprise a screen, display or one or more lights, and may be configured to provide a visual indication of the concentration of methane to a user. Equally, the gas sensor may be configured to provide an audio indication of the concentration of methane to a user (e.g. using a speaker). A visual or audio indication may be provided continuously, periodically, or in response to the concentration of the target gas (e.g. methane) exceeding a predetermined level or dropping below a predetermined level.

Additionally or alternatively, the gas sensor may be configured to transmit its measurements to a remote device for monitoring or processing of the measured data. This transmission may occur over a network containing both wired and wireless components. The gas sensor may transmit raw data (e.g. the output signal, short path reference and/or internal reference signal as measured) and/or processed measurements (e.g. a concentration of methane derived from the output signal). For example, one or more of the output signal, short path reference signal and/or internal reference signal may be transmitted to a remote computing device. This remote computing device may be arranged to process the data, performing a compensation or correction of the output signal based on the short path reference signal and/or the internal reference signal in the manner discussed above.

As mentioned methods and processes described herein can be embodied as code (e.g., software code) and/or data. Such code and data can be stored on one or more computer-readable media, which may include any device or medium that can store code and/or data for use by a computer system. When a computer system reads and executes the code and/or data stored on a computer-readable medium, the computer system performs the methods and processes embodied as data structures and code stored within the computer-readable storage medium. In certain embodiments, one or more of the steps of the methods and processes described herein can be performed by a processor (e.g., a processor of a computer system or data storage system). It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that is capable of storing computer-readable information/data. Computer-readable media should not be construed or interpreted to include any propagating signals.

It Is important to note that while the present invention has been described in a context of a fully functioning gas sensor, those of ordinary skill in the art will appreciate that the processes of the present invention are capable of being distributed in the form of a computer readable medium of instructions and a variety of forms and that the present invention applies equally regardless of a particular type of signal bearing media actually used to carry out distribution.

Generally, any of the signal processing functionality described in this text or illustrated in the figures can be implemented using software, firmware (e.g., fixed logic circuitry), programmable or non-programmable hardware, or a combination of these implementations. The terms “component” or “function” as used herein generally represents software, firmware, hardware or a combination of these. For instance, in the case of a software implementation, the terms “component” or “function” may refer to program code that performs specified tasks when executed on a processing device or devices. The illustrated separation of components and functions into distinct units within the block diagrams above may reflect an actual physical grouping and allocation of such software and/or hardware, or can correspond to a conceptual allocation of different tasks performed by a single software program and/or hardware unit. Thus, the various processes described herein can be implemented on the same processor or different processors in any combination.

The components of the systems discussed above may be connected by any wired or wireless connections. The processors described above may be located local to the optical components of the gas sensor or remotely.

Although specific embodiments of the disclosure have been described, various modifications, alterations, alternative constructions, and equivalents are also encompassed within the scope of the disclosure. Embodiments of the present disclosure are not restricted to operation within certain specific data processing environments, but are free to operate within a plurality of data processing environments. Additionally, although embodiments of the present disclosure have been described using a particular series of transactions and steps, it should be apparent to those skilled in the art that the scope of the present disclosure is not limited to the described series of transactions and steps. Various features and aspects of the above-described embodiments may be used individually or jointly.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims. The modifications and variations include any relevant combination of the disclosed features.

What is claimed is:

1. A gas sensor for detecting a concentration of methane in a gas sample, the gas sensor comprising:
a sample chamber for containing the gas sample;
a light emitting diode arranged to emit infrared radiation into the sample chamber;
a first infrared detector configured to output an output signal based on the radiation it receives; and
a bandpass filter configured to filter radiation passing therethrough;
wherein the light emitting diode, the bandpass filter and the first infrared detector are arranged such that at least a portion of the radiation emitted from the light emitting diode is transmitted through the bandpass filter and along a first optical path through the sample chamber before being received by the first infrared detector;
wherein the bandpass filter has a full width at half maximum, FWHM, in the range from 70 nm to 300 nm and an upper cut-off wavelength of less than or equal to 3350 nm;
wherein the upper cut-off wavelength is the wavelength at which the bandpass filter has a transmittance of 5% of the maximum transmittance of the bandpass filter, the upper cut-off wavelength being greater than a peak wavelength of the bandpass filter at which maximum transmittance occurs; and
wherein the FWHM is a difference between the wavelengths at which the transmittance of the bandpass filter is at 50% of the maximum transmittance of the bandpass filter.

2. The gas sensor according to claim 1, wherein the maximum transmittance of the bandpass filter is at least 65%.

3. The gas sensor according to claim 1, wherein the peak wavelength, at which maximum transmittance of the bandpass filter occurs, is in the range from 3200 nm to 3260 nm.

4. The gas sensor according to claim 1, wherein the FWHM of the bandpass filter is in the range of 80 nm to 200 nm.

5. The gas sensor according to claim 1, wherein the upper cut-off wavelength of the bandpass filter is in the range of 3275 nm to 3325 nm.

6. The gas sensor according to claim 1, wherein the bandpass filter has a lower cut-off wavelength in the range from 3100 nm to 3200 nm, wherein the lower cut-off wavelength is the wavelength at which the bandpass filter has a transmittance of 5% of the maximum transmittance of the bandpass filter, the lower cut-off wavelength being smaller than the peak wavelength of the bandpass filter at which maximum transmittance occurs.

7. The gas sensor according to claim 1, wherein the upper slope of the transmission spectrum of the bandpass filter or the lower slope of the transmission spectrum of the bandpass filter has an average gradient in the range of 0.5% to 1.5%;
wherein the upper slope is the region between an upper shoulder wavelength that is greater than the peak wavelength and at which the transmittance of the bandpass filter is 80% of the maximum transmittance value of the bandpass filter and the upper cut-off wavelength, and the lower slope is the region between a lower cut-off wavelength and a lower shoulder wavelength that is smaller than the peak wavelength and at which the transmittance of the bandpass filter is 80% of the maximum transmittance value of the bandpass filter.

8. The gas sensor according to claim 1, further comprising:
a first mirror positioned along the first optical path and configured to reflect radiation from the light emitting diode to the first infrared detector.

9. The gas sensor according to claim 8, wherein the first mirror is flat, concave, parabolic or spherical.

10. The gas sensor according to claim 1, further comprising:
a second infrared detector configured to output a short path reference signal based on the radiation it receives;
wherein the light emitting diode and the second infrared detector are arranged such that a portion of the radiation emitted from the light emitting diode is transmitted along a second optical path through the sample chamber before being received by the second infrared detector;
wherein a length of the first optical path through the sample chamber is greater than a length of the second optical path through the sample chamber.

11. The gas sensor according to claim 10, wherein the length of the first optical path is at least twice the length of the second optical path.

12. The gas sensor according to claim 10, further comprising:
a second mirror positioned along the second optical path and configured to reflect radiation from the light emitting diode to the second infrared detector.

13. The gas sensor according to claim 10, wherein the light emitting diode, the bandpass filter and the second infrared detector are arranged such that a portion of the radiation emitted from the light emitting diode is transmitted through the bandpass filter and along the second optical path through the sample chamber, before being received by the second infrared detector.

14. The gas sensor according to claim 1, further comprising:
a third infrared detector configured to output an internal reference signal based on the radiation it receives;
wherein the light emitting diode and the third infrared detector are arranged such that a portion of the radiation emitted from the light emitting diode is received by the third infrared detector from the light emitting diode without being transmitted through the sample chamber.

15. The gas sensor according to claim 14, wherein the light emitting diode and the third infrared detector are arranged such the radiation received by the third infrared detector from the light emitting diode is transmitted along a third optical path, and wherein the third optical path is shorter than the first optical path and a second optical path.

16. The gas sensor according to claim 14, further comprising:
an internal chamber disposed between the light emitting diode and the third infrared detector, wherein the internal chamber is separate from the sample chamber;
and wherein the gas sensor is arranged such that the portion of radiation received from the light emitting diode by the third infrared detector is transmitted along a third optical path extending through the internal chamber;
wherein the internal chamber contains a vacuum or partial vacuum, or is filled with a gas or gas mixture that is substantially transmissive to infrared radiation in the range from 3100 to 3400 nm.

17. The gas sensor according to claim 1, further comprising a processor, the processor configured to:
receive the output signal from the first infrared detector;
receive a short path reference signal from a second infrared detector and/or an internal reference signal from a third infrared detector;
compare the output signal with the short path reference signal and/or the internal reference signal;
determine the concentration of methane in the sample chamber based on the comparison of an electromagnetic spectra of the output signal and the short path reference signal and/or the internal reference signal; and
output an indication of the concentration of methane in the sample chamber.

18. The gas sensor according to claim 17, wherein comparing the output signal with the short path reference signal and/or the internal reference signal comprises:
calculating a ratio between the output signal and the short path reference signal and/or the internal reference signal or calculating the difference between the output signal and the short path reference signal and/or the internal reference signal; and
wherein determining the concentration of methane in the contents of the sample chamber comprises:
estimating a proportion of radiation emitted by the light emitting diode absorbed by the contents of the sample chamber based on the calculated ratio between the output signal and the short path reference signal and/or the internal reference signal or the calculated difference between the output signal and the short path reference signal and/or the internal reference signal; and
calculating the concentration of methane in the sample chamber based on the estimated proportion of radiation emitted by the light emitting diode absorbed by the contents of the sample chamber.

19. A method for detecting a concentration of methane in a gas sample, comprising:
providing a gas sensor comprising
a light emitting diode arranged to emit infrared radiation into a sample chamber configured for containing the gas sample;
a first infrared detector configured to output an output signal based on the radiation it receives; and
a bandpass filter configured to filter radiation passing therethrough;
wherein the light emitting diode, the bandpass filter and the first infrared detector are arranged such that at least a portion of the radiation emitted from the light emitting diode is transmitted through the bandpass filter and along a first optical path through the sample chamber before being received by the first infrared detector;
wherein the bandpass filter has a full width at half maximum, FWHM, in the range from 70 nm to 300 nm and an upper cut-off wavelength of less than or equal to 3350 nm;
wherein the upper cut-off wavelength is the wavelength at which the bandpass filter has a transmittance of 5% of the maximum transmittance of the bandpass filter, the upper cut-off wavelength being greater than a peak wavelength of the bandpass filter at which maximum transmittance occurs; and
wherein the FWHM is a difference between the wavelengths at which the transmittance of the bandpass filter is at 50% of the maximum transmittance of the bandpass filter;
receiving, by a processor, the output signal from the first infrared detector and a short path reference signal from a second infrared detector and/or a internal reference signal from a third infrared detector;
comparing, by the processor, an electromagnetic spectra of the output signal and the short path reference signal and/or the internal reference signal; and
determining, by the processor, the concentration of methane in the sample chamber based on the comparison of the electromagnetic spectra of the output signal and the short path reference signal and/or the internal reference signal; and
outputting, by the processor, an indication of the concentration of methane in the sample chamber.

20. A gas sensor for detecting a concentration of a target gas in a gas sample, comprising:
a sample chamber for containing the gas sample;
an infrared light emitting diode arranged to emit infrared radiation into the sample chamber;
a first infrared detector configured to produce an output signal based on the radiation it receives;
a second infrared detector configured to produce a short path reference signal based on the radiation it receives;
a third infrared detector configured to produce an internal reference signal based on the radiation it receives;
a first mirror positioned along a first optical path and configured to reflect radiation from the light emitting diode to the first infrared detector;
a second mirror positioned along a second optical path and configured to reflect radiation from the light emitting diode to the second infrared detector;
wherein the light emitting diode, the first mirror and the first infrared detector are arranged such that a portion of the radiation emitted from the light emitting diode is transmitted along the first optical path through the sample chamber, reflected by the first mirror and received by the first infrared detector;
wherein the light emitting diode, the second mirror and the second infrared detector are arranged such that a portion of the radiation emitted from the light emitting diode is transmitted along the second optical path through the sample chamber, reflected by the second mirror and received by the second infrared detector;
wherein a length of the first optical path through the sample chamber is greater than a length of the second optical path through the sample chamber; and
wherein the light emitting diode and the third infrared detector are arranged such that a portion of the radiation emitted from the light emitting diode is received by the third infrared detector from the light emitting diode without being transmitted through the gas sample to be tested and without being transmitted through a bandpass filter.
